(19) United States
(12) Patent Application Publication
(10) Pub. No.: US 2007/0235950 A1
(43) Pub. Date: Oct. 11, 2007

(54) Chuck

(76) Inventors: Michael Biedermann, Buchs (CH); Vera Nuebel, Munich (DE); Oswin Burtscher, Nueziders (AT); Udo Hauptmann, Landsberg (DE); Markus Hartmann, Mauerstetten (DE); Matthias Kuemmerle, Pfaeffikon (CH); Rainer Kussmaul, Kaufering (DE); Helmut Specht, Bad Woerishofen (DE); Erwin Manschitz, Germering (DE)

Correspondence Address: ABELMAN, FRAYNE & SCHWAB, 666 THIRD AVENUE, 10TH FLOOR, NEW YORK, NY, 10017, US

(21) Appl. No.: 11/784,876

(22) Filed: Apr. 9, 2007

(30) Foreign Application Priority Data
Apr. 10, 2006 (DE) 10 2006 000 168.0
May 9, 2005 (EP) PCT/EP05/04992

(51) Int. Cl. B23B 31/00

(52) U.S. Cl. 279/19

(57) ABSTRACT

A chuck for a rotary and/or percussion power tool includes a rotatable sleeve-shaped base body (1), and at least two wear-resistant guide shells (6, 7) located within the base body and connected with the base body (1) for joint rotation therewith and having projecting radially inwardly entraining elements, with at least one of the at least two guide shells (6, 7) being radially displaceable in the base body (1) within certain limits and forming a projecting radially inwardly locking member (9).

### BACKGROUND OF THE INVENTION

1. Field of the Invention

The present invention relates to a rotatable and/or percussion-driven tool such as drill bit, chisel, or crown bit for treating stone, concrete and masonry.

2. Description of the Prior Art

Generally, a chuck for receiving a shank of a working tool which is rotated and percussion-driven by a hand-held power tool, includes, e.g., according to German Publication DE 26 18 596, an insertion sleeve that extends longitudinally along an axis and has inner cylindrical guide surfaces, projecting radially inwardly rotation-imparting webs, and displaceable radially inwardly locking members. The locking members engage in locking grooves of a shank of an associated working tool and limit an axial displacement of the working tool. At the power tool side, the torque is transmitted by the two entraining webs that engage in corresponding trapezoidal grooves formed in the working tool. The shape of the locking grooves corresponds somewhat to the shape of the locking members, primarily balls. As a result of a high surface pressure generated due to the transmission of the torque to the working tool, the entraining webs, which are located radially inwardly relative to the guide surfaces, are subjected to high wearing forces that limit the service life of the chuck. In particular with chucks for hand-held power tools used in the constructional industry for treating brittle material such as concrete and masonry and which produce an abrasive waste, a reduced wear of chucks is important for the reliability of the hand-held power tools. With each new generation, hammer drills become more and more powerful, and the use time of the hand-held power tools increases, while their performance also becomes more and more comfortable. With improved materials of the working tools, drill bits with larger diameters are used more and more. This condition limits and reduces the service life of a power tool. The breakdowns are caused by abrasive wear of different contact pair components, such as entraining webs with respect to the trapezoidal grooves; balls in the grooves of a shank; balls in their receptacles; and support surfaces in the chuck.

U.S. Pat. No. 3,525,531 and German Publication DE 100 44 387 disclose a chuck with a separate, wear-resistant guide sleeve with projecting radially inwardly rotation-imparting means. German Publication DE 34 16 964 discloses a chuck having a separate, wear-resistant guide sleeve with a locking element formed on one side of the sleeve. For receiving a shank with locking grooves with closed end sides, the guide sleeve is half-open at its side opposite the locking element, which permits the shank to pass thereinto in an inclined position. The drawback of this solution consists in that in this axial position, the shank is not displaceable, which is not suitable for high-power hand-held power tools.

In addition to the wear problem, the chuck is subjected to a heavy load when in a case of an idle impact, the working tool impacts the locking elements of the chuck and before that, a large kinetic energy of the working tool cannot be reduced by friction because of a very short non-cutting path. After a hard impact, the working tool moves again against the die, activating again the percussion mechanism. This process is periodically repeated.

Accordingly, the object of the invention is to provide a chuck having a long service life despite being subjected to heave loads.

### SUMMARY OF THE INVENTION

This and other objects of the present invention, which will become apparent hereinafter, are achieved with a chuck for a rotatable and/or percussion-driven tool, an including a rotatable sleeve-shaped base body and wear-resistant guide means located within the base body, connected with the base body for joint rotation therewith and having projecting radially inwardly rotation-imparting means. The guide means is formed of at least two guide shells of a wear-resistant material and at least one of which is radially displaceable in the base body within certain limits and forms a projecting radially inwardly locking member.

Two wear-resistant guide shells with rotation-transmitting means provide guide means capable to withstand heavy loads, and the projecting radially inwardly locking member, which is formed on one of the radially displaceable, within certain limits, guide shell, permits to eliminate the wear-prone contact pair: locking member-guide sleeve.

An outwardly pivotal movement of the guide shells, which takes place upon tilting of the working tool from its coaxial orientation, provides for locking/release. The working tool is displaced into its coaxial position by being circumferentially displaced.

Advantageously, the locking member is formed as a spherical cap, which insures compatibility of the inventive chuck with conventional chucks having a locking ball.

Advantageously, the guide shell, which is provided with the locking member, is supported in the base body for a limited axial displacement therein. The guide shell thereby is displaced in the operational (impact) direction during an idle impact and prevents further return movement of the tool. Thus, periodically repeated idle impacts are prevented.

Advantageously, the rotation-imparting means has at least two, projecting radially inwardly longitudinally extending, entraining webs. This insures compatibility with chucks having two or three entraining webs.

Advantageously, the rotation-imparting means is arranged on another of the at least two guide shells which does not have a projecting radially inwardly locking member, so that only this guide shell would be pivoted outwardly by the working tool.

Advantageously, the guide shell, which is provided with the rotation-imparting means forms means that project radially outwardly for imparting rotation to the guide means. The radially outwardly projecting means has, advantageously, longitudinally extending webs which engage in the matching entraining recesses formed in the base body. Thereby, a suitable transmission of a torque from the base body to the guide shells, which transmit rotation to the working tool, takes place.

Advantageously, the base body has an inclined surface extending in a direction toward an inner radial expansion. Thereby, at least the guide shell that has the locking member, is radially displaceable into the radial expansion.

Advantageously, the guide shells form, in their locking position, a substantially circumferentially closed receiving region for a shank of a matching associated working tool, which limits penetration of the abrasive material into other areas of the chuck.

Advantageously, the guide shells are axially formlockingly connected with each other, advantageously, by a rough axial toothing. Thereby, the axial displacements of both guide shells are coordinated.

Advantageously, the guide shells are formlockingly connected, at their working tool-side ends, with an elastic dust protective cap. Advantageously, the formlocking connection means is formed by respective, projecting radially outwardly, bands which form respective elastic pivot point for the guide shells.

Advantageously, the base body forms a working tool-side, axial stop band that can be engaged by projecting radially outwardly stop surfaces of the guide shells.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a cross-sectional view of a chuck according to the present invention along line I-I in FIG. 2 in a locking position;

FIG. 2 a cross-sectional view of a chuck according to the present invention along line I-I in FIG. 2 in a locking position (upper part of the drawing shows an idle percussion position, and lower part of the drawing shows an operating percussion position); and

FIG. 3 a longitudinal cross-sectional view of the inventive chuck in a release position.

### DETAILED DESCRIPTION OF THE PREFERRED EMBODIMENT

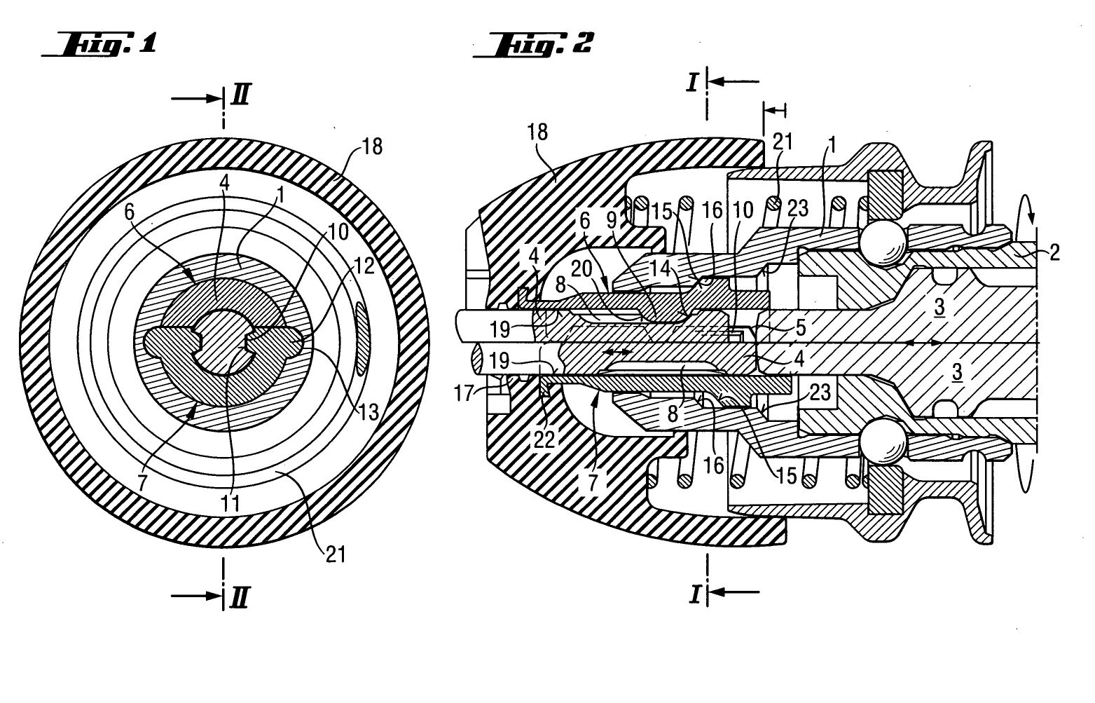

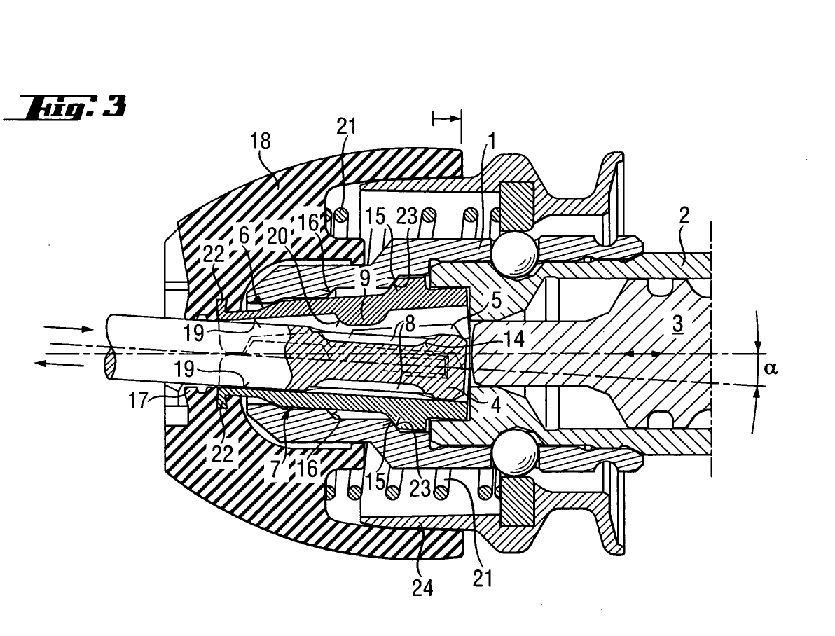

A chuck according to the present invention, which is shown in FIGS. 1-2, has a sleeve-shaped base body 1 releasably connected, at its power tool side, with a rotatable tubular tool spindle 2 that guides a reciprocating die 3 which transmits an impact energy of a hammer drill percussion mechanism (not shown) to a shank 4 of a not shown further, working tool. At the working tool-side end of the base body 1, there are provided two guide shells 6 and 7 for coaxially centering and guiding the shank 4 (locking position). The two guide shells 6 and 7 are formed of a highly wear-resistant steel and are axially formlockingly connected with each other by an axial toothing 5. The guide shell 6 has a spherical cap-shaped locking member 9 that is adapted to a locking groove 8 of the shank 4. The torque transmission is effected by the guide shell 7 having two, diametrically opposite, longitudinally extending entraining webs 10 which engage in entraining grooves 11 formed in the shank 4 and which are open at the hammer drill side of the shank 4. The shell entraining means 12 in form of two, diametrically opposite outer webs of the guide shell 7 engage in matched longitudinal grooves 13 of the base body 1. The guide shells 6 and 7 form, in the locking position, a circumferentially closed, receiving region for the shank 4 of a matching associated working tool.

The lower part of FIG. 2 shows an operational position of the hammer drill in which the working tool is pressed against a constructional component, not shown. As a result, of cooperation of the locking groove 8 with the locking member 9, the guide shell 6 is displaced in an axially central position of the base body 1. Thereby, the other guide shell 7, which is formlockingly axially connected with the guide shell 6 by the axial toothing 5, is also displaced in the same axial central position. The axial displacement of the guide shells 6, 7 is limited by an axial impact of the shank 4 against the die 3 (percussion position). The necessary axial displacement of the shank 4, which is needed during the operation of the hammer drill, is insured by a conventional appropriate length difference between the locking groove 8 and the locking member 9.

The upper part of FIG. 2 shows a non-percussion position in which the power tool is lifted off the constructional component, and the working tool, together with the shank 4, moves somewhat axially out of the chuck, being released by a pulse of the die 3. As a result of the displacement of the shank 4, an axial stop 14 of the locking groove 8 engages the locking member 9, and the guide shell 6 and the guide shell 7, which is connected with the guide shell 6 by the axial toothing 5, are also displaced somewhat from the chuck until the guide shells 6, 7 engage with their stop surfaces 15 an axial stop collar 16 of the base body 1 (idle non-percussion position). As a result of friction between the shank 4 and the guide shells 6, 7, between the guide shells 6, 7 themselves, and between the guide shells 6, 7 and the base body 1, the kinetic energy of the working tool is reduced, whereby the shank 4 arrives at an axial rest position, in which no impact contact with the die 3 is possible.

When a working tool is to be inserted in the chuck, the user pushes the shank 4 through sealing lips 17 of a dust protective cap 18, which is formed of an elastomer, along guide surface 19 of the guide shells 6, 7. The shank 4, engaging the working tool-side front flanks 20 of the locking member 9, displacing the guide shells 6, 7 relative to the base body 1 axially in the direction of the power tool in a release position shown in FIG. 3, in which the power tool-side ends of the guide shells 6, 7 open radially outwardly as a result of pressure applied by the shank 4. The tilted, relative to the axis by an angle (α), shank 4 is submerged beneath the locking member 9. The biasing force of a compression spring 21 then displaces the elastic dust protective cap 18 and the guide shells 6, 7, which are pivotally connected with the cap 18 by a respective band-shaped, projecting radially outwardly, locking element 22, back into the locking element 22, back into the locking position (shown in the upper part of the drawing in FIG. 2), with the guide shells 6, 7 being displaced radially inwardly by inclination surfaces 23 of the base body 1 acting on the power tool-side ends of the guide shells 6, 7, and with the locking body 9 engaging in the locking groove 8. The elastic locking elements 22 act as pivot points for the guide shells 6, 7. The dust protective cap 18, together with the integrated sealing lips 17, forms a dust seal and, together with other sealing elements 24 of the chuck, forms a labyrinth against an undesirable penetration of dust in the chuck and toward the base body 1.

For removing a working tool from the chuck, the user displaces the duct protective cap 18 against the biasing force of the spring 21 toward the power tool. Because of the locking element 22, the guide shells 6, 7 would be likewise displaced axially from their locking position (shown in the upper half of FIG. 2) and would become radially disengaged from the base body 1. When the shank 4 is pulled out, the guide shells 6, 7 pivots about the pivot point, which is formed by the locking element 22, radially outwardly due to the action of the axial stop 14 of the locking groove on the guide shells 6, 7. The shank 4, which again is tilted toward the chuck axis, becomes axially unlocked and can be withdrawn. The biasing force of the compression spring 21 again displaces the guide shells 6, 7 and the dust protect cap 19 in the non-percussion position. Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A chuck for a rotary and/or percussion power tool, comprising a rotatable sleeve-shaped base body (1); and wear-resistant guide means located within the base body (1) and connected with the base body (1) for joint rotation therewith and having projecting radially inwardly rotation-imparting means, the guide means being formed of at least two guide shells (6, 7) of a wear-resistant material at least one of which (6) is radially displaceable in the base body (1) within certain limits and forms a projecting radially inwardly locking member (9).

2. A chuck according to claim 1, wherein the locking member (9) is formed as a spherical cap.

3. A chuck according to claim 1, wherein the at least one shell (6) is supported in the base body (1) for a limited axial displacement therein.

4. A chuck according to claim 1, wherein the rotation-imparting means comprises at least two, projecting radially inwardly, longitudinally extending, entraining webs (10).

5. A chuck according to claim 1, wherein the rotation-transmitting means is arranged on another of the at least two guide shells (7) which does not have a projecting radially inwardly locking member (9).

6. A chuck according to claim 5, wherein another of the at least two guide shell (7) forms means (12) projecting radially outwardly for imparting rotation to the guide means.

7. A chuck according to claim 1, wherein the base body (1) has an inclined surface (23) extending in a direction towards an inner radial expansion.

8. A chuck according to claim 1, wherein the guide shells (6, 7) form in a locking position thereof, a substantially circumferentially closed receiving region for a shank (4) of a matching associated working tool.

9. A chuck according to claim 1, wherein the at least two guide shells (6, 7) are axially formlockingly connected with each other.

10. A chuck according to claim 1, further comprising a dust protective cap (18), wherein the at least two guide shells (6, 7) are provided, at working tool-side ends thereof with formlocking means (22) for connecting the at least two guide shells (6, 7) with the dust protective cap (18).

11. A chuck according to claim 1, wherein the base body (1) forms a working tool side axial stop band (16).
